(19) United States
(12) Patent Application Publication
(10) Pub. No.: US 2006/0106804 A1
(43) Pub. Date: May 18, 2006

(54) Electronic equipment and method for carrying out communication with electronic equipment

(75) Inventor: Suresh Chande, Vantaa (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/978,088

(22) Filed: Oct. 28, 2004

(51) Int. Cl. G06F 7/00; G06F 17/30

(52) U.S. Cl. 707/10

(57) ABSTRACT

A portable electronic equipment is disclosed, which can be adapted to be in connection with a data transmission network and which comprises as functionalities application means for forming and/or processing application means data, which application means can be adapted to carry out data transmission comprising at least application means data at least with some of the functionalities of the equipment in an established manner, input means for inputting input means data to the equipment, and form means, which can be arranged in connection with the equipment and to which chosen data can be input by chosen means, and the data of the form means can be processed by an established quarter in an established manner. Between the form means and at least some of the application means of the equipment is adapted to carry out data transmission comprising at least application means data.

### FIELD OF THE INVENTION

The invention concerns portable electronic equipment, which can be adapted to be in connection with a data transmission network and which comprises as functionalities
application means for forming and/or processing application means data, which application means can be adapted to carry out data transmission comprising at least application means data at least with some of the functionalities of the equipment in an established manner,
input means for inputting input means data to the equipment, and
form means, which can be arranged in connection with the equipment and to which chosen data can be input by chosen means, and the data of the form means can be processed by an established quarter in an established manner.

In addition, the invention also concerns corresponding method, system and a program product for implementation of the method according to the invention.

### BACKGROUND OF THE INVENTION

Forms have been widely used by web based enterprise systems for presentation of information and extraction of information from human users. Some application examples in which forms are exploited are transactional systems and authorizations. Forms are also used for data submission from end users. Some examples of these are preferences, profiles, address, billing contacts, etc.

In prior art this information is then processed by systems to perform it some enterprise/web system specific manner. Some examples of these manners are the use of scripting languages, servlets, web tools, etc. In general, humans users are well aquianted with the usage of forms for data input.

However, there are some serious disadvantages and limitations with current form based applications. First of them is that end user requires to manually complete the information that is required to be filled into the forms. Also the user interaction is quite cumbersome with when using forms. Forms are typically defined for the collection of information from end-users, typically data of simple and very generic data-types, such as text data, for example.

Due to the user equipment—enterprise system interaction the forms are utilized in a connected mode only. The disadvantage caused by this is that the connection must be up during filling the form and there is also performed data transmission between user device and enterprise system. This may cause, for example, some connection problems, if the user is caught during the filling of the form, for example, to the area that is not covered with mobile network.

Furthermore, the processing of the forms is based on a server hosted solutions. This causes that it is not possible to process form data with the current equipment that already have developed data processing and presentation capabilities. Also, the application of the forms, are not well suited, for example, for mobile usage due to the cumbersome user interfaces and keypad and limited displays, for example.

A one reference to the literature in which is presented the prior art for the use of the forms, is a book “Information technology for management” written by Efraim Turban et al. (ISBN 0-471-21533-3) see reference [1].

Another reference to the prior art is a form solution provided by Celesta (see reference [2]). This solution relates to the mobile access to enterprise information and forms are applied to get this access. The forms are used in a disconnected mode in connection with a local database that may be browse and update. The changed data may be then synchronized with the server-based infrastructure. However, this solution has a drawback that relates to the communication between other clients. It is difficult to arrange the communication to be happening in an organized manner if the workgroup has, for example, several members.

### SUMMARY OF THE INVENTION

The purpose of the present invention is to bring about a way to communicate, collect and process the collected information which is effortless and which is especially suitable for portable equipment. The characteristic features of the electronic equipment according to the invention are presented in the appended Claim 1, 41 and 42 and the characteristic features of the method are presented in Claim 12. In addition, the invention also concerns a corresponding communication device system and a program product, whose characteristic features are presented in the appended Claims 22 and 26.

The portable electronic equipment according to the invention, can be adapted to be in connection with a data transmission network and comprises as functionalities
application means for forming and/or processing application means data, which application means can be adapted to carry out data transmission comprising at least application means data at least with some of the functionalities of the equipment in an established manner,
input means for inputting input means data to the equipment, and
form means, which can be arranged in connection with the equipment and to which chosen data can be input by chosen means, and the data of the form means can be processed by an established quarter in an established manner.

In the equipment between the form means and at least some of the application means of the equipment is adapted to carry out data transmission comprising at least application means data.

Furthermore, in the method according to the invention for processing forms, in which method one or more portable pieces of equipment are applied, which can be connected to a data transmission network, of which equipment at least some comprise as functionalities
application means, which can be used to form and/or process application means data and which are used to carry out data transmission comprising at least application means data at least with some of the functionalities of the equipment in an established manner,
input means, which can be used for inputting input means data to the equipment, and
form means, which can be arranged in connection with the equipment and to which chosen data can be input by chosen means,
   and in which method
data is input to the form means, and
data of the form means is processed by an established quarter in an established manner.

In the method between the form means and at least some of the application means of one or more pieces of the equipment carry out data transmission comprising at least application means data.

Furthermore, in the communication device system according to the invention, which system comprises two or more portable pieces of communication equipment, which communication equipment can be adapted to carry out chosen mutual communication carried out in an established form using a chosen bearer and wherein at least some equipment comprise as functionalities
application means for forming and/or processing application means data, which application means can be adapted to carry out data transmission comprising at least application means data with at least some functionalities of the equipment in an established manner,
input means for inputting input means data to the equipment, and
form means, which can be arranged in connection with the equipment and to which chosen data can be input by chosen means, and the data of the form means can be processed by an established quarter in an established manner.

In the system between the form means and at least some of the application means of the equipment is adapted to carry out data transmission comprising at least application means data and that said communication of an established form is adapted to be carried out by using said form means.

Furthermore, in the program product according to the invention for processing forms, which program product comprises a storing medium and a program code executable by processor means and written in the storing means, which program code is adapted for execution in connection with a portable piece of electronic equipment, which is adapted to be in connection with a data transmission network and which equipment comprises as functionalities
application means for forming and/or processing application means data, which application means can be adapted to carry out data transmission comprising at least application means data at least with some functionalities of the equipment in an established manner,
input means for inputting input means data to the equipment, and
form means, which can be arranged in connection with the equipment and to which chosen data can be input by chosen means, and the data of the form means can be processed by an established quarter in an established manner.

The program code comprises a first code means configured to carry out data transmission comprising at least application means data between at least some of the application means of the equipment and the form means, and said data transmission comprises inputting of application means data from the application means to the form means and/or retrieval of application means data from the form means to the application means. The concept of “application means” may be understood very largely in the context of the invention. According to a first embodiment, it can be a device that forms data in connection with the equipment. According to another embodiment, it can be a application program by which data can be produced and by which data can be processed. The concept of “data transmission” can also be understood very largely in the context of the invention. According to a first embodiment, it can be transmission from the form to the application means. According to a second embodiment, it can also be transmission from the application means to the form means.

Owing to the invention, numerous advantages to do communication and information gathering are achieved. A first advantage is achieved in allowing for user's to feed information to gathering systems in a simplified manner. The user may now deploy several different application specific data types, which are formed in connection with the equipment and which are available from the native platforms.

The invention also enhances communication amongst equipment users. Owing to the invention it is possible to provide a request system for core application specific data that is formed and processed in the equipment. This is achieved by arranging the close integration of form based applications to equipment core applications. When data analysis of gathered data is performed locally in connection with the equipment more versatile analysis actions become possible. The end user may tailor himself the desired data analysis and actions targeted to the data and actions that is performed in prior art in server based systems are now possible also in connection with the equipment. Processing function may be embedded in the form structure or it can also be in the equipment environment like in application program. It may also be a separate program module that is executed separate from form or application programs. Possibilities are various.

The invention also makes possible for mobile users to perform communication in a powerful manner. According to one embodiment the communication may be implement a peer-to-peer arrangement. Combining this arrangement to the core application data is achieved an effect architecture that doesn't need at all, for example, server based systems.

Other characteristic features of the invention will emerge from the appended claims, and more achievable advantages are listed in the specification.

### BRIEF DESCRIPTION OF THE DRAWINGS

The invention, which is not limited to the embodiments to be presented in the following, will be described in greater detail by referring to the appended figures, wherein

FIG. 1a is a rough schematic view of a principle application example of the equipment according to the invention,

FIG. 1b shows a principle application example of applications arranged in the equipment according to the invention,

FIGS. 2a-2c show some principle application examples of communication possibilities between pieces of equipment,

FIG. 3 shows a first application example of the system according to the invention applied to the method for collecting information,

FIG. 4a shows another application example of the system according to the invention applied to the method in a log application,

FIG. 4b shows a second application example of the system according to the invention applied to the method in reservation of meeting rooms,

FIG. 4c shows a third application example of the system according to the invention applied to the method for management of image information and

FIG. 4d shows a fourth application example of the system according to the invention applied to the method in a map-ordering service.

### DETAILED DESCRIPTION OF THE INVENTION

The method concerns a method, system and electronic equipment 10 implementing the method for applying forms in communication between pieces of electronic equipment 10, 10.1-10.6.

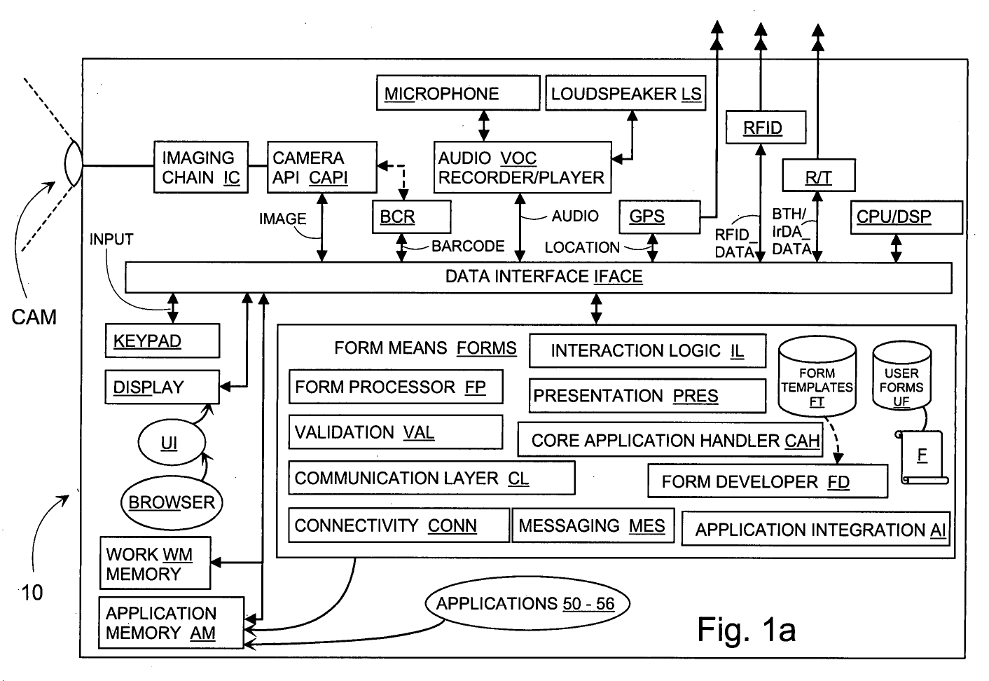

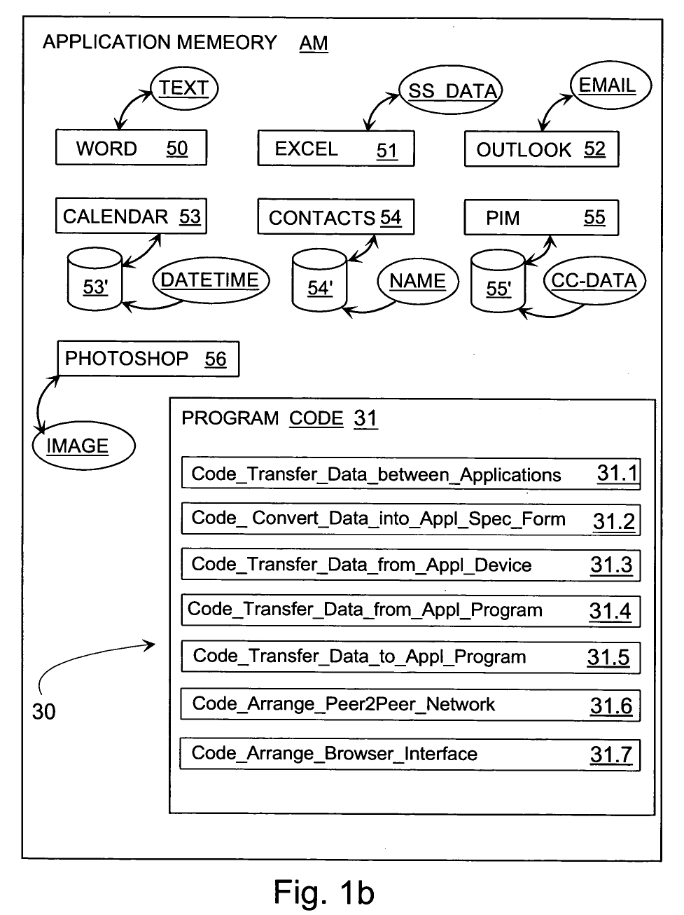

FIG. 1 shows an example of portable electronic equipment 10 according to the invention, which equipment can be connected to communicate in a data transmission network. The equipment 10 may be, for example, mobile equipment, such as, for example, a mobile station, equipment of the PDA (Personal Digital Assistant) type or some equivalent wireless intelligent communication equipment.

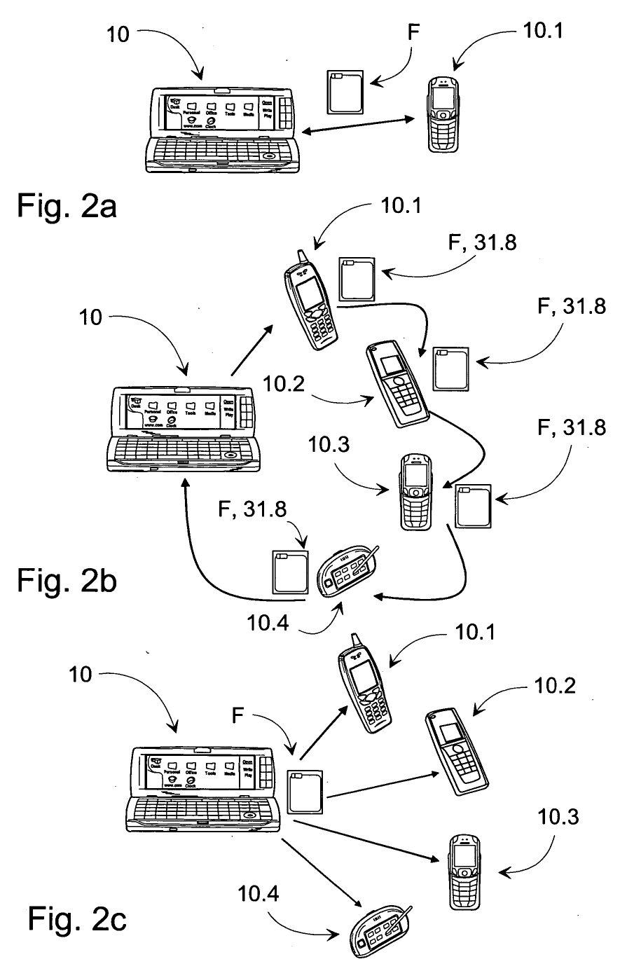

The equipment 10 may as one functionality be provided with transmission and reception modules R/T, which need not be described in any greater detail in this context. With these modules the equipment 10 can connect to be in connection with one or more data transmission networks 11-14, 100 to carry on in an established manner communication with other two or more parties 10.1-10.4 possibly connected to the network 11-14, 100 (FIGS. 2a-2c, 3, 4a-4d).

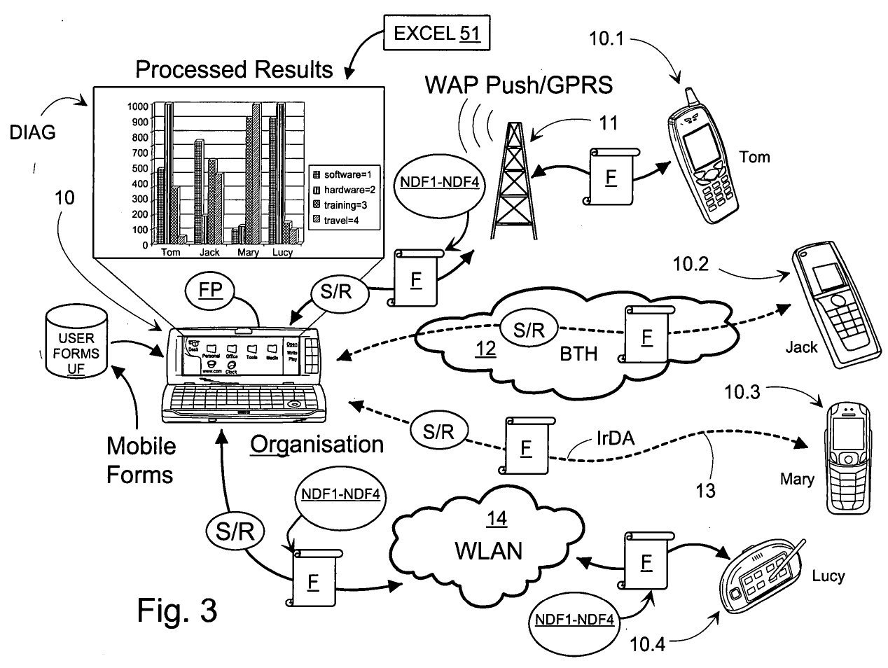

The data transmission network 11 may be a mobile station network (for example, WCDMA) of a kind known as such, or it may also be a wireless local area network 12-14 (such as, for example, BTH (Bluetooth), IrDA (Infrared DAta) or WLAN (Wireless Local Area Network), wherein data is transmitted signalled and applying a selected protocol, such as, for example, WAP (Wireless Application Protocol), SMS (Short Message System), MMS (Multimedia Messaging System) as the transmission format. Combinations of these are, of course, also possible. The messaging module MES in the equipment 10 is responsible to establish connection using a messaging infrastructure in order to transfer and receive data i.e. in the case of the invention forms F, and form responses (MMS, SMS, JMS, etc.). The data to be transmitted and received by these pieces of equipment 10, 10.1-10.4 is packed into a signal (the S/R arrows in FIG. 3). The network system to be applied in the invention does not either limit the application areas of the invention in any way. The bearer type of the transmission and reception means R/T may be, for example, packet-switched for example, GPRS (General Packet Radio Service), CDMA (Code Division Multiple Access), WCDMA (Wideband Code Division Multiple Access) or circuit-switched, for example, CSD (Circuit Switched Data). The connectivity CONN module is responsible in the equipment 10 to establish connectivity, between pieces of equipment to exchange information i.e. in the case of the invention the forms F (GPRS, WLAN, BTH, etc). The communication layer CL is a general communication abstraction layer, which will make the form application F transparent to the underlying communication/connectivity layer COMM, CL utilized for transferring/receiving the forms irrespective of the radio/packet switched network used to exchange the form/form submission results. The wireless data transmission network infrastructure 11, if the used network even needs one, may comprise a base transceiver station, a router and other network means known as such to allow communication in the network system 11 (not shown).

Furthermore, the equipment 10 may as functionalities comprise one or more application means CAM, 51. Application means can be understood very largely in the context of the invention. According to a first embodiment, they may comprise one or more data forming means, more generally data source CAM, VOC, GPS in connection with the equipment 10 for forming application means data IMAGE, AUDIO, LOCATION. In some situations, these data forming means may also be able to process, for example, the application means data formed by them, such as, for example, the case may be with camera means CAM.

As some although in no way limiting examples of one or more application means there are camera means CAM, IC, CAPI for doing digital imaging, that is, for forming image data IMAGE, audio recording and reproduction means VOC, MIC, LS for recording and reproducing sound AUDIO, positioning means GPS for finding out, for example, location data LOCATION of the equipment 10, radio frequency identification means RFID for reading remote identifiers RFID_DATA, bar code reading means BCR for reading bar codes BARCODE, etc. There are not need for all means listed above but at least some of them may be implemented in connection with the device.

Camera means may be formed, for example, by a camera sensor CAM, which is known as such and which is suitable for digital imaging, and for this the equipment 10 may be provided with a corresponding imaging chain IC for forming image data IMAGE understood as application means data in this case and for processing it by equipment 10. The imaging ability of the equipment 10 may comprise, for example, still/video imaging, as this is not limited in any way by the invention. In the imaging chain IC, it may also be possible to process image data IMAGE, which is not necessarily even formed by the equipment's 10 own camera sensor CAM, but which may be supplied to the equipment 10 in some other way. Thus, of the data forming means referred to in the invention at least some may also be able to process application means data.

The audio recording and reproduction means may comprise, for example, microphone means MIC with a audio circuit VOC for capturing sound and digitalizing it into audio data AUDIO understood as the application means data, as well as loudspeaker means LS with a audio circuit VOC for reproducing the digitalized audio data AUDIO, which is possibly captured by the equipment's 10 microphone means MIC. It is possible to apply audio recording and reproduction means MIC, LS, VOC just for storing and reproducing sound, or they may of course also be applied, for example, even in connection with the above-mentioned video imaging.

The positioning means may comprise, for example, a GPS (Global Positioning System) module, which can be used, for example, for carrying out positioning of the equipment 10 with a certain accuracy by applying a special satellite positioning system. Hereby, the application means data can be understood, for example, as location data LOCATION, such as, for example as location coordinates determined from a GPS system. Such a functionality possibly arranged in the equipment 10 may also be regarded as positioning means, by which the location of the equipment 10 at each time is applied in the positioning of the equipment 10, for example, in a wireless data transmission network system 11.

The bar code reading means BCR can be implemented, for example, by using camera means CAM, IC, CAPI or also as a reader proper. Bar codes BARCODE may be of 2D or 3D form.

Of the data formed from the external sources of equipment 10 it is possible to apply, besides audio and image data AUDIO, IMAGE, also electronic data transmission signals, for which the equipment 10 includes data forming means. According to a first embodiment, the equipment 10 may hereby have RFID (Radio Frequency Identification) means. In the equipment 10, these may be as their own module RFID known as such, which may be used for communicating with a remote target as RFID_DATA. The remote target may also be a tag-like RFID element known as such (not shown).

In the case of the invention, even the data transmission means R/F of the equipment 10 can be understood as data forming means as regards its certain functions. For example, in the case of local network applications, such as, for example Bluetooth or IrDA, data BTH_DATA, IrDA_DATA may be input to the equipment 10 from a desired peripheral device, which may be, for example, in the case of image data IMAGE a camera device separate from the equipment 10, or in the case of audio data AUDIO a hands-free headset (not shown) separate from the equipment 10 or in the case of location data LOCATION a GPS-module separate from the equipment 10. Also other local network applications and remote means are possible.

On the other hand, the application means of the equipment can also be understood as one or more application programs arranged in the equipment 10, besides data forming means or instead of these. As an example of such applications specialized in information of certain types can be mentioned, of which information in text form TEXT, image information IMAGE or information in table form, such as, for example, spreadsheet data SS_DATA, can be mentioned as examples. The corresponding application programs may hereby be a text processing application 50 (for example, Word), an image processing application 56 (for example, Photoshop) and a spreadsheet application 51 (for example, Excel). The applications 50-56 may be arranged, for example, on a storage medium belonging in connection with the equipment 10, such as, for example, in an application memory AM of a re-writable memory type, for example. Of course, the applications or their functionalities may also be downloaded or executed from the network system. From the application memory AM, the applications 50-56 can be downloaded in a manner known as such, for example, into the work memory WM of the equipment 10 and run by a processor CPU.

At least some application programs 50-56 can be used for processing application means data IMAGE, AUDIO, LOCATION, TEXT, SS_DATA. Processing can also be understood largely in connection with the invention. In the case of a text processing application 50, processing may be, for example, editing of the text TEXT in the desired manner or searching it for a string of characters of an established form, for example. In the case of an image processing application 56, processing may be, for example, processing of image data IMAGE in the desired manner. In the case of a spreadsheet application 51, processing may be, for example, performance of desired calculations on numeric tabulated data SS_DATA or forming from data SS_DATA a graphic description DIAG of a desired kind (FIG. 3). Thus, there are numerous applications, and they are not limited in any way by the invention.

On the other hand, the application programs 50-56 or at least some of them may of course also be used for forming application means data. The text-processing program 50 may be used for creating text TEXT, wherein desired special effects or styles, for example, may be set. The image-processing program 56 may be used to create image data IMAGE and the spreadsheet program 51 may be used to tabulate, for example, numerical data SS_DATA.

Furthermore, various applications 55 of the database type and databases 55′ can also be understood as application means. In these, for example, established application means data CC_DATA can be maintained in an arranged manner and, for example, searches understood as processing may be performed therein. Data may be added to and also removed from the database 55′. An example of a database is the PIM database 55′ and the corresponding application PIM 55 (Personal Information Management). In a database 55′ of this kind there may be, for example, user-specific information, such as, for example, the user's payment/credit card data CC_DATA. Furthermore, the application means may be, for example, combinations of application programs 52-54 and databases 52′-54′. An example of such may be a contact data application 54. In this one may maintain, for example, contact data NAME of persons, which data can be updated and which can be increased, fetched and edited by a contact data application 54 from a contact data database 54′. Another example could be a calendar application 53, which can be used for operating, for example, a calendar database 53′, which can be updated. Time management information DATETIME may be maintained therein. Various applications of the TaskList type and electronic mail applications 52 (for example, Outlook) are of course also possible. A feature common to the above-mentioned application program data TEXT, IMAGE, SS_DATA, NAME, DATETIME, CC_DATA could be, for example, that it can be reused, for example, in some other context.

The equipment 10 may also include input means KEYPAD for inputting input means data INPUT to the equipment 10. Examples of input means are various control buttons/switches, keypads KEYPAD and input means of the plotter stylus type. Besides for inputting INPUT data, the KEYPAD input means may also be used for controlling the functions of the equipment 10, for example, from the user interface UI of the equipment 10 shown on the display DISP.

The functionalities of the equipment 10 also include form means FORMS, which can be arranged in connection with the equipment 10 and to which selected data INPUT, such as, for example, text data, can be input by selected means, such as, for example, by the keypad KEYPAD of the equipment 10. The form means FORMS may be, for example, form applications FD, which the user can tailor and use for developing forms UF according to his needs to perform desired functions. In connection with the developer may be a database for form templates FT. Templates FT may comprise a collection of the pre-developed forms using which the user may develop with developer FD desired forms UF.

Referring to FIGS. 1 and 3, the receiving means R of the equipment 10 can be used for receiving forms F containing or not containing data from a data transmission network 11-14 from one or more quarters 10, and the transmission means T can be used for transmitting forms F containing or not containing data to one or more quarters 10.1-10.4 in a data transmission network 11. If the form F, which may have been received by the equipment 10.1-10.4 by downloading or which the equipment 10.1-10.4 may have received as a push service, for example, from some commercial or enterprise quarter 10, it is usually intended for filling in by the user with the equipment 10. Then, in accordance with the state of the art, the form F is transmitted by the equipment 10.1-10.4 as a form containing data to the quarter 10 set as the recipient, which collects the data by fetching it from the received forms F and by processing it in an established manner in order to achieve the desired purpose. Placing an order for a product/service could be an example of this.

If the form F, which may have been received by the equipment by downloading or as a push service, for example, from some commercial or enterprise quarter, contains some data, it is usually in accordance with the known technology meant for processing at least partly by the equipment in an established manner.

The form F received by the equipment 10.1, 10.4 can, of course, also contain data. The purpose in that case may be that the user needs to fill in information to the form F, but also some information can also be included in the form F which is sent by the requestor 10. The respondent on filling in information and submitting the response can have two affects.

Some information may locally update the user's own equipment 10.1-10.4 and some information can also be sent back to the requestor's equipment 10 for further processing.

The application means of the equipment 10, which were already described extensively above, such as, for example, camera means CAM and application programs 50-56, or at least some of the application means CAM, 50-56 of the equipment 10, may carry out at least some of the functionalities of the equipment 10 in the established manner, at least data transmission comprising application means data IMAGE, AUDIO, LOCATION, BAR-CODE, RFID_DATA, BTH/IrDA_DATA, TEXT, SS_DATA, NAME, DATETIME, CC_DATA. To this end, the functionalities of the equipment 10 described above are arranged to be in data transmission connection and having interfaces IFACE with one another. The connection may be inside the equipment 10. Hereby the equipment 10 includes data interfaces IFACE, which are used for transmitting data between the functionalities. Hereby the different functionalities, such as, for example, data forming means CAM and form means FORMS of the equipment 10, have data transmission interfaces CAPI, IFACE, AI, CAH through which data transmission can be performed. The interfaces IFACE and protocol interfaces CAPI are also technology known as such to a person skilled in the art, so there is no need to go into them any further in this context. FIG. 1 shows a camera interface CAPI and form interface AI, CAH as an example of interfaces.

At least some of the application means of the equipment 10 may in a surprising manner carry out at least data transmission containing application means data with the form means FORMS. The data transmission between application means and forms may be triggered by chosen quarter. Besides the application means CAM, GPS, 50-56 it can be triggered by form means FORMS or by some other functionality, which doesn't depend on application means CAM, GPS, 50-56 or form means FORMS. By such data transmission surprising advantages are achieved even in many different respects. For this purpose there are arranged a program code 31, which comprises a code 31.1 configured to deal out this function. In more general, there may be an application integration module AI that is responsible for integrating and extracting data to the forms F from the underlying the native platform. Also, the core application handler module CAH is provided in the equipment 10 that is a utility module which the application integration module AI can utilize to communicate with the standard core applications CAM, 50-56, for example, of the pieces of mobile equipment 10.

The form means FORMS or form application F may include as a sub-module an interaction logic module IL. It is the logic using which a set of actions are executed in the form processor FP which correspond the user interactions with the form UI. The actions could be, for example, updating the core applications in the equipment, for example, adding a business card, updating the calendar entry or even initiating a phone call depending on data elements embedded within the form. Simpler type of the action can be, for example, converting and embedding the form data into an Excel sheet.

Firstly, to the form means FORMS, to forms F in particular, the invention allows inputting of surprising data forms of core applications of the equipment (for example, PIM, IMAGE, GPS), besides or instead of merely state-of-the-art input data, for example, input data in text form INPUT. The use of core application data allows integration either to the core application or extracting from the core application. On the other hand, the invention now allows easier use of all forms of data of the forms F also in the applications 50-56 of the equipment 10. The invention makes possible an application interaction in both directions with the form application FORMS. According to one embodiment, data originating, for example, in a form may be collected therein, for example, in such a way that an established local application 50-56 is called and the relevant data is fetched from the form F to the application 50-56 for processing. Hereby it is possible to utilize the versatile functions provided by the applications 50-56, implementation of which is not necessarily possible in an easy way with the actual form means FORMS.

The data transmission between the application means CAM, VOC, GPS, 50-56 and the forms F can be understood as unidirectional or even as bi-directional. It can be at different times or at the same time. The data transmission may comprise, for example, inputting (embedding/updating) of application means data, such as, for example, image information IMAGE, to the form means FORMS. For this purpose the program code 31 may have code 31.3 to execute this action. On the other hand, it can also be retrieval (extraction) of application means data from the form means F, besides or instead of inputting F. In the case of inputting, the invention simplifies inputting of information to the form F. According to one embodiment, the taking out of information from the application may even take place automatically with the local application acting as the host.

The data IMAGE, SS_DATA may already be in an application-means-specific form when arriving, for example, from the camera means CAM or from the spreadsheet program 51. The image data IMAGE may be, for example, in jpeg file form and the spreadsheet data SS_DATA in XLS file form, if the Microsoft Excel spreadsheet software 51, for example, is applied. On the other hand, the data may also be converted only in connection with the data transmission into an application-means-specific form. The equipment 10 hereby also includes corresponding conversion program code 31 that comprises code 31.2 configured to convert the application-means-specific data into form data and vice versa.

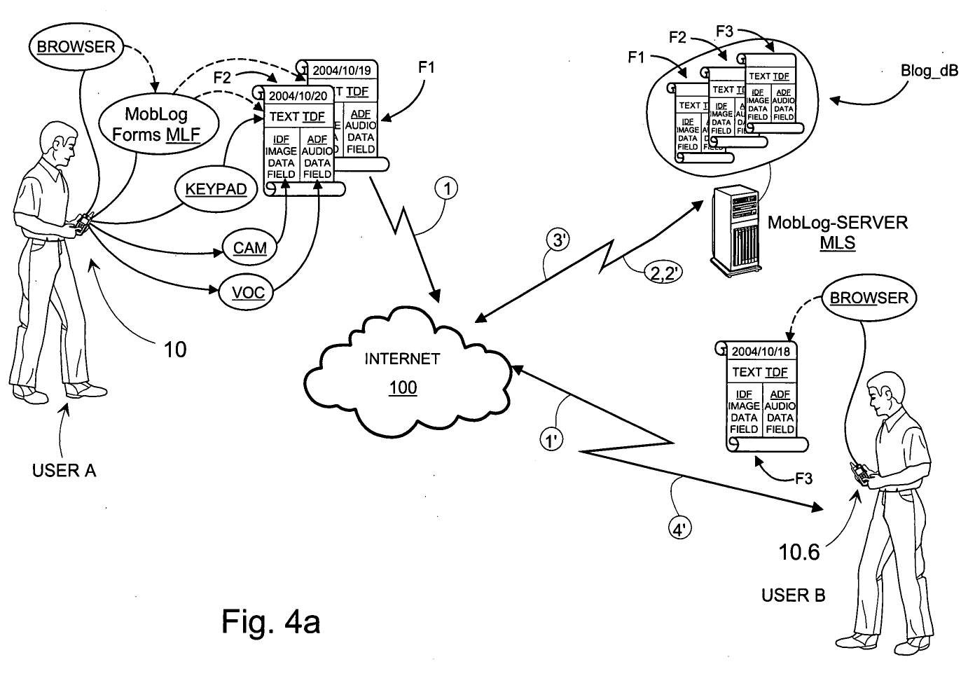

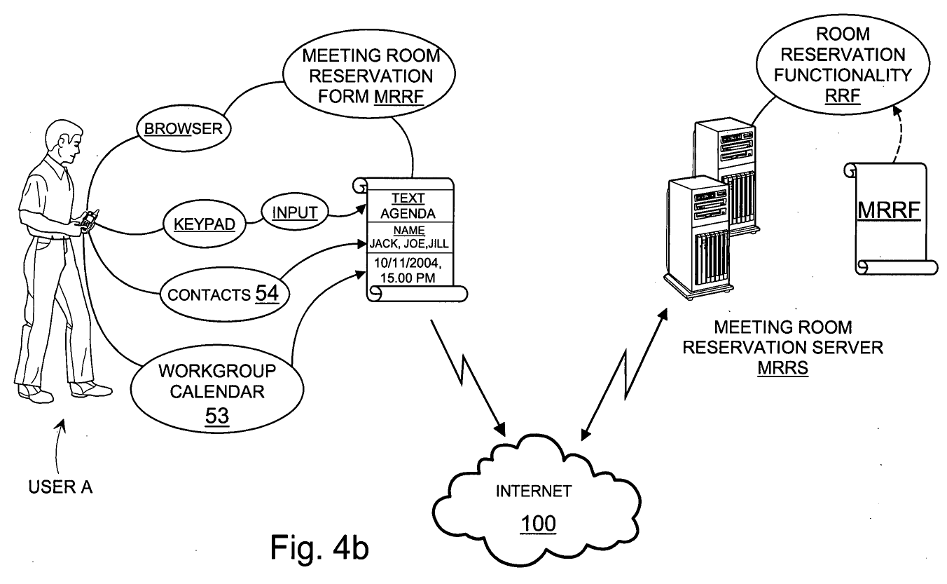

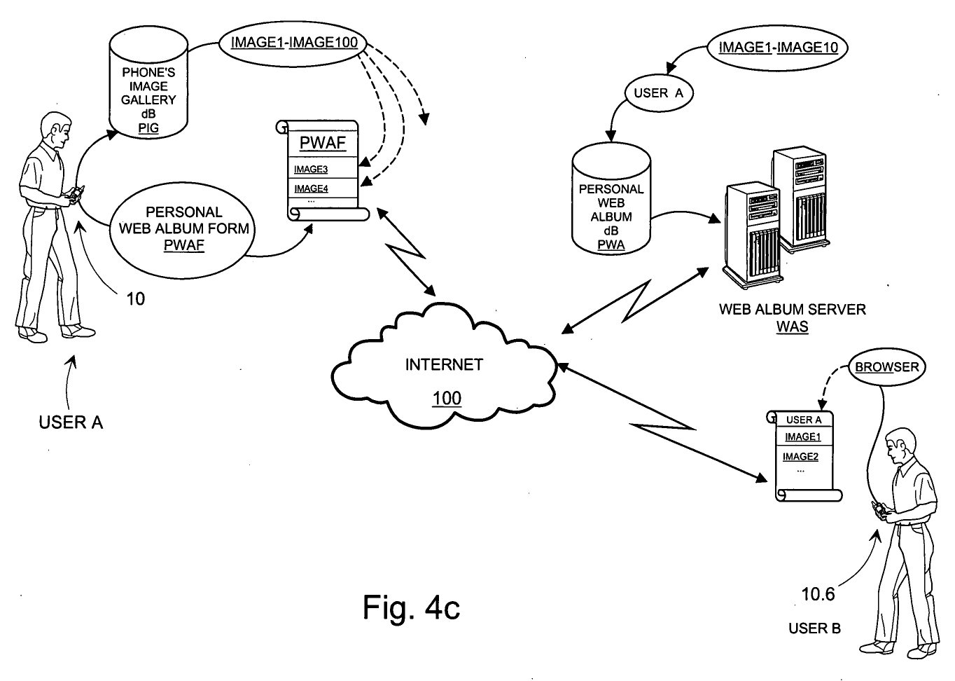

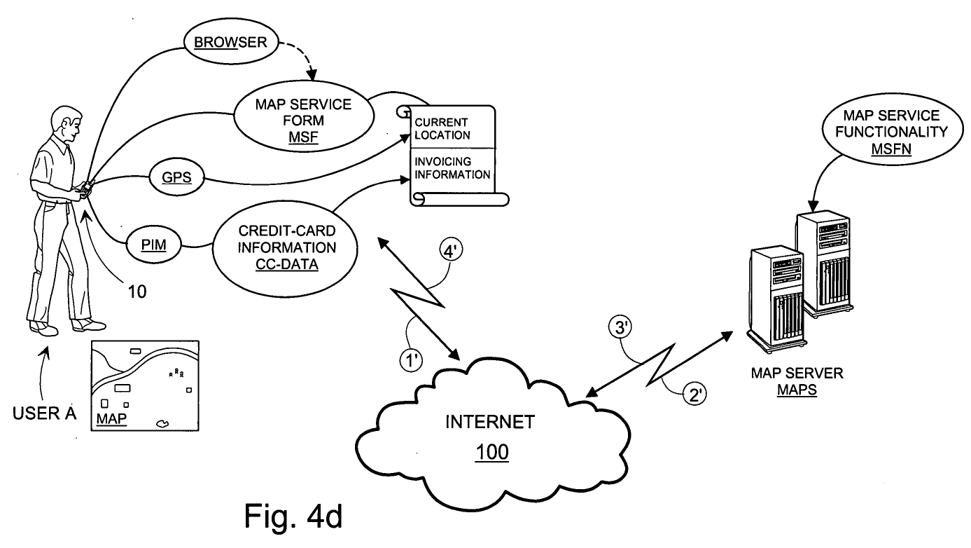

The forms F comprise one or more data fields TDF, IDF, ADF (for example, FIG. 4a). Of these each one is adapted for format-specific data TEXT, IMAGE, AUDIO of an established form. Hereby one or more form fields IDF arranged for the application means data, such as, for example, image data IMAGE, may accept as input only such image data IMAGE, which is in the established format specific to the data forming means and which has been formed in an established manner by the data forming means CAM and which can then be input to the concerned field IDF.

Correspondingly, at least some application programs 50-56 can be used for inputting application means data SS_DATA to at least some data fields NDF1-NDF4. The program code 31 comprises code 31.4 configured to execute the routines relating to this action. The concerned data fields NDF1-NDF4 will hereby accept as input only such data SS_DATA, which is specific to the application program. Hereby the one or more data fields NDF1-NDF4 arranged for the table data SS_DATA may accept as input, for example, only in the form of table data SS_DATA. It may be, for example, numerical data, which may additional be provided, for example, with set spacer characters.

With both the above-mentioned cases a program code 31.3, FP, for example, may hereby be arranged in connection with the fields IDF, which program code will allow, for example, presentation of image date IMAGE as visual and rational image information in the concerned image field IDF and presentation of table data SS_DATA, for example, in an easily interpreted table form in the concerned field. Of the table data SS_DATA a graphic presentation DIAG of the desired kind can of course also be formed, for example, in the field, this is of course also possible. Graphic presentation DIAG may also be formed in the spreadsheet application 51.

According to one embodiment, data transmission between the form means FORMS and at least some data forming means may be carried out directly through agency by the interfaces CAPI, CL of the equipment's 10 functionalities. According to one embodiment, data transmission may be carried out in connection with the forming of application means data IMAGE. Hereby when doing, for example, imaging with the camera means CAM, it is even possible to display a view finder image on the form F shown on the display DISP of the equipment 10 in the field IDF reserved for image data IMAGE. When triggering the camera means CAM for doing imaging, the stored image data IMAGE is embedded into the form F in connection with the concerned field IDF and the image information formed of the image data IMAGE is presented visually in the concerned field IDF. With such a direct data transmission between the functionalities, which of course is here explained as an individual example, the user achieved an extremely tangible emotion when filling in the form F. The user can now compose the image to be in good balance with other content of the form. Instead of real time data transfer between application means 50-56, CAM, GPS etc. and forms F the data can also be inputted to forms F, of course, from mobile file system, for example (not presented). In addition to or also besides the circumstance that at least some application programs 50-56 may be used for inputting application program data TEXT, SS_DATA, more generally application means data, into the form F in one or more fields TDF, IDF, ADF arranged for it, at least some application programs 50-56 can also be used for retrieving data SS_DATA at least from some data fields NDF1-NDF4 of the form F. After such retrieval, at least a part of the retrieved data SS_DATA can be processed by the equipment 10 in an established manner. For this purpose the program code 31 comprises a code 31.5 configured to execute the routines relating to this action.

The equipment 10 may also comprise browser means BROWS of a kind known as such. The (X) HTML browser BROWS can be mentioned as an example, which is found by now in several portable communication devices 10, 10.1-10.6. According to one embodiment, the browser means BROWS may be arranged as a user interface for the form means FORMS. The program code 31.7 is adapted to arrange said browser BROWS as a user interface UI for the forms F. The format of forms F is hereby of some type that can be presented and processed by using the browser BROWS.

FIGS. 2a-2c show some examples of communication equipment systems according to the invention. The invention enhances communication amongst mobile users. The communication equipment system may be formed, for example, by applications of the type shown in FIGS. 2a-2c, wherein the communication is performed by two or more pieces of portable communication equipment 10, which can be connected to a data transmission network and at least some of which can carry on communication with one another. The communication equipment 10, 10.1-10.4 may carry on mutual communication in an established manner by using a chosen bearer, such as, for example, a mobile station network 11 or a wireless local area network 12-14.

Of the equipment 10, 10.1-10.4 at least some comprise the functionalities shown in the equipment embodiment presented in FIG. 1. Of the equipment 10.1-10.4 some may be stripped, even comprising only a browser BROWS or some equivalent form user interface, a possible keypad KEYPAD and as application means, for example, a digital camera CAM. In addition, all the pieces of equipment 10, 10.1-10.4 in the system have transmission and reception means R/T, so that they can communicate with the other pieces of equipment 10, 10.1-10.4 using a chosen bearer by form means.

The embodiment of FIG. 2a shows form communication according to the invention between two pieces of equipment 10, 10.1.

FIG. 2b shows an application, where the communication is performed from one piece of equipment 10 to several pieces of equipment 10.1-10.4, in general, between multiple pieces of equipment, in a routed manner. Here the communication may take place, for example, in a local area network or in fixed mobile network. The equipment 10, 10.1-10.4 is used to form a peer-to-peer network arrangement, wherein the communication is performed by form means FORMS. The transmission and receiving means R/T of each piece of equipment 10, 10.1-10.4 are now adapted to form a peer-to-peer network arrangement together with the other parties 10, 10.1-10.4 belonging to the data transmission network. The program code 31 comprises a code 31.6 configured to form this network arrangement.

In the communication, forms F containing data are routed for transmission in an established order from one piece of equipment 10, 10.1-10.4 to another. Each piece of equipment 10, 10.1-10.4 is used to process the forms F in an established manner, whereby the processing includes, for example, the input and/or retrieval of data from the forms F, as was already mentioned above.

The form F according to the invention can be distributed to a number of people/target recipients 10.1-10.4 in predetermined order in well declarative manner. In the form F may be embedded some sort of mark-up language definition, for example. The decision of the manner of how the form F is exchanged, distributed and processed in the equipments 10, 10.1-10.4 may be based on these declarative definitions 31.8 embedded into the forms F.

FIG. 2c shows an application, where the communication takes place from one piece of equipment 10 to more, in this case four, pieces of equipment 10.1-10.4. The communication may be sequential or parallel.

In the following, the method according to the invention will be described in greater detail with reference to the operating application shown as an example in FIG. 3, wherein several different bearers are applied by way of example. The system there comprises five parties 10, 10.1-10.4, of which one party 10 may represent the management of an enterprise organisation ORG and four parties 10.1-10.4 may represent different departments or persons who are in responsible for them ((Tom, Jack, Mary, Lucy). Thus the invention also allows for mobile user's to feed information to enterprise information systems in a simplified manner.

In the application example, an organisation ORG is collecting data on the IT expenses of different departments. The enterprise organisation ORG has equipment 10 having functionalities, for example, of the kind shown in FIG. 1 including functionalities FP for processing the forms F. The organisation ORG may send a form F collecting expense data to the different parties 10.1-10.4, for example, at fixed times. On the other hand, it is in no way necessary to send an empty form F containing no data. Hereby the equipment 10.1-10.4 of the parties may be provided, for example, with an enterprise-specific form library including a form F custom-made for collecting expense information, on which expense information the parties 10.1-10.4 must report to the organisation ORG, for example, at established intervals.

The departments fill in the form F presented by the browser BROWS visualised on the display DISP of the equipment 10.1-10.4 by inputting to it numerical data, for example, by using the keypad KEYPAD of the equipment 10.1-10.4. In this case, the form F includes four numerical data fields NDF1-NDF4. The fields NDF1-NDF4 concern software=1, hardware=2, training=3 and travelling=4 expenses of the departments. According to one embodiment, data can be input to the forms when the equipment 10.1-10.4 is in a non-data-transmission state in relation to the communication equipment system 11-14. The program code 31 may be arranged to control this. The connected mode is also possible, of course. For example, when applying packet data, a non-data-transmission state is to be understood such that there is hardly any essential data transmission taking place concerning a form or data to be input to it, but the only data transmission there is the “heartbeat” data, which is characteristic of packet data. The advantages achieved with such OFF-line filling is that the user can fill the form F at moment of time that he wants, without the need to maintain a live connection to the services. Filling can be done in flight, in a tunnel when sitting in a train, etc. The communication of the form F can also be delivered over any asynchronous channel such as MMS/SMS messaging. One advantage to fill the form F in an offline mode is also that the user can decide to do that partly now and partly later and can complete the form F filling in his own pace. After the filling in, the forms F are sent to the equipment 10 of the organisation ORG in the signal S/R that is also one object of the invention.

The equipment 10 managed by the organisation ORG receives forms F containing data and carries out processing of them and of the data they contain, in this case all numerical data, in the manner according to the invention, whereby the quarter processing the data of the form means F can be understood as this equipment 10 of the organisation ORG. With the equipment 10 or, for example, with a form processor FP belonging to its form means FORMS, performance of, for example, a light spreadsheet application 51 is triggered, which as a data transmission retrieves the expense data from the data fields NDF1-NDF4 of the forms F received by the equipment 10. The spreadsheet application 51 in this context may has only some basic functions, such as, forming of a graphical presentation DIAG from the received numerical data. The expense data is processed in a spreadsheet application 51 in an established manner, which in this case is, for example, such that of it, in this case of all the retrieved data, a column diagram is formed, which is processed in the equipment 10 in the desired manner, such as, for example, by storing it in a fixed memory or by directing it to some application specialized in expense follow-up. Numerical data may also be directed directly to some suitable financial management application. The processing of the forms F is now possible besides the traditional server hosted solutions also in the equipment 10 hosted manner.

Besides the form processor FP located in the form means FORMS of the equipment 10, the triggering starting the processing, that is, the spreadsheet application 51 and retrieval of the data from the forms F to the spreadsheet application 51, may be embedded as a code being executed by the equipment 10 or by the virtual processor of its browser BROWS, also in the form F proper. As forms F are being received by the equipment 10, they may themselves by and by activate transmission of data to the spreadsheet application 51, wherein an established diagram presentation DIAG is formed of it. Also, the spreadsheet application 51 may monitor the special folder in the equipment's storing medium to which the received forms F are stored. The application 51 fetches the forms F when they appear to the folder. There are numerous alternatives for implementing the program code 31.1-31.7 according to the invention. In general, the code causing the actions required from the invention can be, for example, in Java, some suitable scripting language, XML or even native Symbian or corresponding or the combination some of these.

The target mobile device 10 receiving the request forms F from either one/multiple responders 10.1-10.4 at different points of time, will thus maintain the summary for the requesting forms F and process the responses of the users to make a unified response that may further be processed in a desired manner. Thus, in addition to that not only the filling of the forms F on the equipment 10, 10.1-10.4 with core application data is possible owing to the invention, but also submitting the responses back to the mobile user. The mobile equipment 10 may compile and process the response forms F and can make, for example, some presentation, such as, a bar chart in the embodiment described in FIG. 3. The request forms F can be sent to more than one equipment and important advantage has been achieved by that the mobile equipment 10 can receive all the response forms F and process the summarized view about these multiple views.

FIG. 4a shows an embodiment, wherein the invention is applied to a new service for portable equipment 10, 10.1-10.6 made possible by the invention, that is, to the maintenance of a mobile daybook, MobLog. Here the data transmission network 100, which is an IP network in the example, may include a server MLS, which is used to maintain a database Blog_dB on the MobLogs of the different users USER A. The server MLS may be, for example, under the management of a network operator or a service operator. From the server MLS it is possible for USER B with his equipment 10.6 connected to the data transmission network 100 to process, in this case download for reading, the logs of different persons USER A. The browsing equipment 10.6, that is, in this case the processing quarter, may be of a kind known as such, and the reading of log pages F1-F3 may be carried out, for example, using the browser means BROWS of the equipment 10.6.

The equipment 10 writing the MobLog may be provided with the functionalities of the equipment 10 according to the invention. It may be provided with a form developer FD, which the user USER A can use firstly for planning (personalizing) a presentation of MobLog form MLF. In the equipment 10 there may be a presentation module PRES that is intended to formulate the layout for the form F. Also the developer section FP may have validation module VAL that is intended to validate the correctness of the form MLF and its program code that is embedded to it. Generally, the form means FORMS may be implement according to the xforms and/or XML specifications. The form F1-F3 may have fields both for traditional text fields TDF and also, for example, for image data IMAGE, which can be formed by the camera CAM of the equipment 10 and input to the form F1-F3. In addition, to some data fields ADF audio data AUDIO may also be input from a audio recorder VOC, MIC of the equipment, whereby the MobLog F1-F3 may also contain as audio clipping some comments of the user USER A or other sounds recorded by the local audio recorder REC of the equipment 10. When the user USER A has filled in the MobLog form in the manner he likes, he will send it, for example, by pressing a transmission button in the form F1-F3 to the server MLS. In the transmission button a routine transmission function may be hidden, with which the equipment 10 transmits (transmission arrows 1, 2) the form to the server MLS to be filed in the user's USER A MobLog database Blog_dB and to be read by the other users USER B using their equipment 10.6 (request arrows 1′-4′).

An application was presented above, where the user's USER A equipment 10 has a MobLog form template MLF. Such an embodiment is of course also possible that the form MLF to be completed is arranged in connection with the equipment 10 instead of or besides an assortment of forms arranged with the equipment 10 through the data transmission network 100. Hereby the user USER A uses the browser BROWS of his equipment 10 to download an empty form MLF on the display DISP and performs input of data on it in the manner described above. However, here one must perform data transmission to do with image data IMAGE and audio data AUDIO during the filling in of form MLF, which may weaken the user experience. In the previous embodiment, all the data TEXT, IMAGE, AUDIO that was input to the form MLF was transmitted as one structured data transmission upon completion of the form MLF. Here is an advantage, which is achieved for processing of the forms F when the equipment 10 is in a state without connection. When the form MLF is complete, the user USER A stores it in the server MLS.

When the browsing user USER B browses through MobLogs F1-F3 stored in the server MLS, he sees the information presented in the logs properly structured on the forms F1-F3. Thus, the arrangement of forms in connection with the equipment can be understood both as the fixed arrangement of forms F in the equipment 10 and as the downloading for supplementation over the data transmission network 100 and supplementation over the data transmission network 100 in which form templates MLF are in fixed manner in the server MLS.

FIG. 4b shows an embodiment, where the invention is applied to a meeting room reservation service. Here a server MRRS attending to reservations delivered on forms MRRF is connected to a data transmission network 100. The form MRRF, which is in the equipment 10 or which can be downloaded from server MRRS, now has, for example, three fields, one of which is for text data TEXT, one field is for contact information data NAME and one field is for time management data DATETIME. When the user USER A wishes to reserve a meeting room, he can input the agenda for the meeting in the text field of the form MRRF as text data TEXT. In the inputting of data, the invention can be applied, for example, to the contact information field and to the time field. As contact information data NAME the contact application 54 of the equipment 10 inputs into the contact information field the names of the participants in the workgroup, that is, the meeting, and as time management data the workgroup's calendar application 53 inputs in the time management field the times suitable for the workgroup or for its members. The contact information application and the calendar application 54, 53 may also be WEB-based applications, besides applications arranged for the equipment 10. After transmission/acknowledgement of the form MRRF, the server MRRS processes the received form MRRF and reserves for the workgroup a time and a room for the meeting, which is suitable for them.

On the other hand, the meeting reservation embodiment, and other embodiments too, when appropriate, may also include other participants to whom the meeting request form MRRF is sent to in a Peer-2-Peer mode. The meeting participants can then accept/reject the meeting request and these responses are delivered as form responses MRRF to the requester, in addition to responses from the meeting reservation server MRRS. In this embodiment a reference is made to the FIG. 2b.

When a form F is sent from the requester the recipient and when the recipient is filling in information and submitting the response, the action of submitting a response to the requester can also update something locally into the equipment 10.1-10.4 of the recipients. For example in the case of embodiment when a meeting request as a form is sent to multiple recipients, on accepting the request by submitting the response the form application FP can update the local calendar application 53.

Furthermore, in the application shown in FIG. 4c, the user USER A may on the form PWAF compile images IMAGE1-IMAGE10 to be transmitted from his equipment's 10 image gallery PIGdB to a WEB album server WAS arranged in the data transmission network 100. Hereby, the form PWAF may have fields IDF for image data IMAGE, where those images IMAGE3-IMAGE4 can be downloaded, which are to be transmitted. The image collage, which is in a database PWAdB, for example, as forms, can again be browsed by other users USER B.

Furthermore, in the embodiment shown in FIG. 4d, the user USER A wishes to have for his equipment 10 a map MAP information corresponding to his present location.

For the ordering of a map, location information LOCATION on the equipment's 10 position at the time, which information is obtained, for example, from the GPS module of the equipment 10, can be supplied to the equipment 10 or to a form MSF arranged in the data transmission network in the server MAPS. For invoicing of the map service, the user's USER A credit card number and its expiration information CC_DATA can also be input to the form MSF, which number may be fetched, for example, from a PIM database 55′. The form MSF is sent to a server MAPS, whose functionality MSF will process it and send to the equipment 10 in response a map MAP corresponding to the reported location.

In FIG. 1b is presented a rough schematic view of an application example of a program product 30 according to the invention. The program product 30 may include memory means AM and a program code 31 executable by the processor unit CPU of the equipment 10 and written in the memory means AM for dealing with forms in accordance with the method of the invention at least partly in the software level. The memory means AM for program code 31 may be, for example, a memory card adaptable in connection with portable equipment, CD media adaptable in a PC environment or also a static or dynamic application memory of the equipment 10, wherein it can be integrated directly.

The program code 31 may include several code means 31.1-31.7 described above, which can be executed by processor means CPU and the operation of which can be adapted to the method descriptions just presented above. The code means 31.1-31.7 may form a set of processor commands executable one after the other, which are used to bring about the functionalities desired in the invention in the equipment 10 according to the invention.

It is obvious to a professional in the art that the program codes 31 may be implemented in an established manner either as independent applications or they may also form modules. Hereby at least some of them can be integrated or linked up with other applications, such as, for example, with the above-mentioned application programs 50-56 or also with forms UF, F, MLF, MRRF, PWAF, MSF or directly on the operating system level.

In the case of RFID tag, described above, the form F can fetch the details by reading the RFID tag. The data RFID_DATA received from the RFID tag can be processed and some derived data can be added into the form F or then the RFID tag data RFID_DATA could be directly embedded into the form F. In the case of processing the RFID tag, detailed data RFID_DATA can be accessed locally or remotely and embedded into the right parts of the form F fields.

In the connection of the invention data transmission is adapted to carry out between the form means F and at least some of the application means CAM, VOC, GPS, 50-56 of the equipment 10 comprising at least application means data. Data transmission may be understood as transfer of data between the above functionalities. In connection of the description above, for example, the terms “inputting”, “retrieving” and “fetching” is to be understood expressions for these transfer actions. The triggering to the inputting and retrieving may be originated from several quarters. The code that may implement these actions may situate, for example, in connection with the form F, in connection with the application program 50-56 or it may be an independent and separate code somewhere in the equipment 10 logic.

The invention provides a means for enterprise information systems to request and/or deliver for mobile core application specific data. Also the close integration of form based applications to mobile core applications comes true.

In the invention, portable electronic equipment may function as originator of the form process, as form supplier and as the processing environment where the form process will end up. It is not hereby necessary to arrange even any centralized server solution, which would function only in all these duties and where forms would be processed one-sidedly, but the invention makes possible a form data transmission and processing implemented with portable consumer equipment only in the manners described in the embodiments. Also, in the other devices (such as, for example, laptops and (mobile) PC/Workstations, mobile connections embedded, for example, to vehicles) that may have similar connectivity such as BTH, WLAN or IP based, the invention could also be implemented.

The presented invention provides peer-to-peer mobile forms to aid person-to-person or workgroup communication with close integration with core mobile applications. For example, simplification of data input to forms, data delivering to mobile devices and form data processing on the mobile devices remove the need for, for example, server based form processing and allow deployments of forms, for example, in Adhoc-networking environments including, for example, Bluetooth (Point 2 Point, Point to Multipoint), PAN or WLAN and other proximity networks in a pure peer-2-peer mode, or via remote connections over, for example, GPRS, CDMA or eGPRS. Some sort of a proxy may also be applied. The utilising of a messaging infrastructure, such as, for example, MMS or any other IP based messaging framework also fit into a means to exchange forms according to the invention. The special data fields in the forms, described above in the description, has to be understood being more input fields than presentation fields which may be the situation in connection with the forms known from prior art.

It should be understood that the above specification and the figures relating to it are only intended to illustrate the present invention. Thus, the invention is not limited only to the embodiments presented above or to those defined in the claims, but many various such variations and modifications of the invention will be obvious to the professional in the art, which are possible within the scope of the inventive idea defined in the appended claims.

### REFERENCES

[1] E. Turban et al., “Information technology for management”—Transforming business in the digital economy; Internet Appendix: Technology Guides 1 (Hardware), pages TG1-20-TG1-21, Internet URL available on September 2004: http://jws-edcv.wiley.com/college/bcs/redesign/student/resource/0,12264,_{—}0471400750_BKS_{—}1072_{—}142_{—},00.html

[29 Celesta, Brochures: “CELESTA Smart Forms 2”, Internet URL available on October 2004: http://www.celesta.fi/cgi-bin/iisi3.pl?cid=celesta&sid=858&src=Esitteet/SmartForms2.pdf

What is claimed is:

1. Portable electronic equipment, which can be adapted to be in connection with a data transmission network and which comprises as functionalities
application means for forming and/or processing application means data, which application means can be adapted to carry out data transmission comprising at least application means data at least with some of the functionalities of the equipment in an established manner,
input means for inputting input means data to the equipment, and
form means, which can be arranged in connection with the equipment and to which chosen data can be input by chosen means, and the data of the form means can be processed by an established quarter in an established manner,
characterized in that between the form means and at least some of the application means of the equipment is adapted to carry out data transmission comprising at least application means data.

2. Equipment according to claim 1, characterized in that the data transmission comprises inputting of application means data to form means and/or retrieval of application means data from form means, and the application means data is already converted or it can be converted in connection with the data transmission into a form specific to the application means.

3. Equipment according to claim 2, whose application means comprise data forming means adapted in connection with the equipment for forming application means data and wherein the form means comprise one or more data fields, each one of which is adapted for data of an established form, characterized in that the application means data is adapted for inputting into at least some of said data fields, whereby said some data fields are adapted for data specific to the data forming means.

4. Equipment according to claim 3, wherein the data forming means and the form means have data transmission interfaces, characterized in that the data transmission between the form means and at least some data forming means is adapted to take place directly by way of said interfaces in connection with the forming of the application means data.

5. Equipment according to claim 2, whose application means comprise application programs and wherein the form means comprise one or more data fields, each one of which is adapted for data of an established form, characterized in that from at least some application programs is adapted to input application means data into at least some of said data fields, whereby said some data fields are adapted for application program-specific data.

6. Equipment according to claim 2, whose application means comprise application programs and wherein the form means comprise one or more data fields, each one of which is adapted for data of an established form, characterized in that from at least some data fields is adapted to transmit data to at least some application programs and to process the data in the application programs at least in part in an established manner.

7. Equipment according to claim 1, characterized in that the data of the form means is adapted for transmitting and/or processing when the equipment is in a state of non-data-transmission in relation to the data transmission network.

8. Equipment according to claim 1, characterized in that said form means comprise form-developing means and/or transmitting means for transmit forms to a data transmission network and receiving means for receiving forms from a data transmission network and/or processing means for processing forms.

9. Equipment according to claim 8, wherein two or more parties belong to the data transmission network, characterized in that the transmission and receiving means are adapted to form a peer-to-peer network arrangement together with the other parties belonging to the data transmission network.

10. Equipment according to claim 8, characterized in that the equipment is adapted to receive from data transmission network at least two forms including data and to process the data of the forms in an established manner to create a combined information from the data, such as a summary.

11. Equipment according to claim 1 and also comprising browser means, characterized in that said browser means are adapted as a user interface for the form means.

12. Method for processing forms, in which method one or more portable pieces of equipment are applied, which can be connected to a data transmission network, of which equipment at least some comprise as functionalities
application means, which can be used to form and/or process application means data and which are used to carry out data transmission comprising at least application means data at least with some of the functionalities of the equipment in an established manner,
input means, which can be used for inputting input means data to the equipment, and
form means, which can be arranged in connection with the equipment and to which chosen data can be input by chosen means,
and in which method
data is input to the form means, and
data of the form means is processed by an established quarter in an established manner,
characterized in that between the form means and at least some of the application means of one or more pieces of the equipment carry out data transmission comprising at least application means data.

13. Method according to claim 12, characterized in that in the data transmission, application means data is input to the form means and/or application means data is retrieved from the form means, and the application means data is already converted or it will be converted in connection with the data transmission into a form specific to the application means

14. Method according to claim 12, wherein the application means of the equipment comprise data forming means, which are used to form application means data, and the form means comprise one or more data fields, each one of which is adapted for data of an established form, characterized in that application means data is input into at least some of said data fields, whereby said some data fields are adapted for data specific to the data forming means.

15. Method according to claim 12, wherein the data forming means and the form means have data transmission interfaces, characterized in that data transmission between the form means and at least some data forming means is carried out directly by way of said interfaces.

16. Method according to claim 15, wherein the application means of the equipment comprise application programs and wherein the form means comprise one or more data fields, each one of which is adapted for data of an established form, characterized in that from at least some application programs data is input into at least some of said data fields, whereby said some data fields are adapted for data specific to the application program.

17. Method according to claim 12, wherein the application means of the equipment comprise application programs and the form means comprise one or more data fields for data of an established form, characterized in that from at least some data fields is transmitted data to at least some application programs, of which data at least some is processed by an established quarter in an established manner.

18. Method according to claim 12, characterized in that data of the form means is transmitted and/or processed when the equipment is in a state of non-data-transmission in relation to the data transmission network.

19. Method according to claim 12, wherein one or more pieces of equipment belong to the data transmission network, of which at least some can be adapted to carry out mutual communication, characterized in that the pieces of equipment are used to form a peer-to-peer network arrangement, wherein communication is carried out by using form means.

20. Method according to claim 19, characterized in that form means which can be adapted to contain data is routed in the communication for transmission in an established order from one piece of equipment to another, wherein each piece of equipment is used to process the form means in an established manner, whereby the processing comprises input of data and/or retrieval of data from the form means.

21. Method according to claim 12, wherein the equipment also comprises browser means, characterized in that said browser means are adapted as the user interface for the form means.

22. Communication device system, which system comprises two or more portable pieces of communication equipment, which communication equipment can be adapted to carry out chosen mutual communication carried out in an established form using a chosen bearer and wherein at least some equipment comprise as functionalities
application means for forming and/or processing application means data, which application means can be adapted to carry out data transmission comprising at least application means data with at least some functionalities of the equipment in an established manner,
input means for inputting input means data to the equipment, and
form means, which can be arranged in connection with the equipment and to which chosen data can be input by chosen means, and the data of the form means can be processed by an established quarter in an established manner,
characterized in that between the form means and at least some of the application means of the equipment is adapted to carry out data transmission comprising at least application means data and that said communication of an established form is adapted to be carried out by using said form means.

23. System according to claim 22, characterized in that data of the form means is adapted to be transmitted and/or processed when the equipment is in a state of non-data-transmission in relation to the communication system.

24. System according to claim 22, characterized in that at least some of the pieces of equipment are adapted to form a peer-to-peer network arrangement together with the other parties belonging to the data transmission network.

25. System according to claim 22, characterized in that at least some of the pieces of equipment are adapted to collect the data of the form means received from network.

26. Program product for processing forms, which program product comprises a storing medium and a program code executable by processor means and written in the storing means, which program code is adapted for execution in connection with a portable piece of electronic equipment, which is adapted to be in connection with a data transmission network and which equipment comprises as functionalities
application means for forming and/or processing application means data, which application means can be adapted to carry out data transmission comprising at least application means data at least with some functionalities of the equipment in an established manner,
input means for inputting input means data to the equipment, and
form means, which can be arranged in connection with the equipment and to which chosen data can be input by chosen means, and the data of the form means can be processed by an established quarter in an established manner,
characterized in that the program code comprises a first code means configured to carry out data transmission comprising at least application means data between at least some of the application means of the equipment and the form means, and said data transmission comprises inputting of application means data from the application means to the form means and/or retrieval of application means data from the form means to the application means.

27. Program product according to claim 26, characterized in that the program code comprises a second code means configured to convert the application means data in connection with the data transmission into a form specific to the application means.

28. Program product according to claim 26, wherein the application means of the equipment comprise data forming means adapted in connection with the equipment for forming application means data and wherein the form means comprise one or more data fields, each one of which is adapted for data of an established form, characterized in that the program code comprises a third code means configured to input application means data into at least some of said data fields, whereby said some data fields are adapted for data specific to the data forming means.

29. Program product according to claim 26, wherein the data forming means and the form means of the equipment have data transmission interfaces, characterized in that said third code means is configured to implement data transmission between the form means and at least some data forming means directly by way of said interfaces in connection with the forming of the application means data.

30. Program product according to claim 26, wherein the application means of the equipment comprise application programs and wherein the form means comprise one or more data fields, each one of which is adapted for data of an established form, characterized in that the program code comprises a fourth code means configured to input application means data at least from some application programs to at least some said data fields, whereby said some data fields are adapted for data specific to the application program.

31. Program product according to claim 26, wherein the application means of the equipment comprise application programs and wherein the form means comprise one or more data fields, each one of which is adapted for data of an established form, characterized in that the program code comprises a fifth code means configured to retrieve data from at least some data fields and to process it at least in part in at least some established one or more application programs in an established manner.

32. Program product according to claim 26, characterized in that the data of the form means is adapted to be transmitted and/or processed by the program code when the equipment is in a state of non-data-transmission in relation to the data transmission network.

33. Program product according to claim 26, wherein two or more parties belong to the data transmission network, characterized in that the program code comprises a sixth code means configured to form a peer-to-peer network arrangement together with the other parties belonging to the data transmission network.

34. Program product according to claim 26, whereby said equipment also comprises browser means, characterized in that the program code is adapted to arrange said browser means as a user interface for the form means.

35. Use of a camera element for forming data for form means.

36. Use of audio recording means for forming data for form means.

37. Use of positioning means for forming data for form means.

38. Use of the method according to claim 12 for supplying location information to a portable piece of electronic equipment.

39. Use of the method according to claim 12 for gathering data from at least two parties of data transmission network.

40. Signal for carrying out communication between pieces of portable communication equipment in a data transmission network, wherein data of an established form is adapted into the signal, which signal is adapted for transmission using a chosen form of a form.

41. Portable electronic equipment, which can be adapted to be in connection with a data transmission network and which comprises as functionalities
application programs for forming and/or processing application program data, which application programs can be adapted to carry out data transmission comprising at least application program data at least with some of the functionalities of the equipment in an established manner,
input means for inputting input means data to the equipment, and
form means, which can be arranged in connection with the equipment and to which chosen data can be input by chosen means, and the data of the form means can be processed by an established quarter in an established manner,
characterized in that between the form means and at least some of the application programs of the equipment is adapted to carry out data transmission at least from form means towards application programs comprising at least application program data.

42. Portable electronic equipment, which can be adapted to be in connection with a data transmission network and which comprises as functionalities
data source for forming and/or processing data, which data source can be adapted to carry out data transmission comprising at least with some of the functionalities of the equipment in an established manner,
input means for inputting input means data to the equipment, and
form means, which can be arranged in connection with the equipment and to which chosen data can be input by chosen means, and the data of the form means can be processed by an established quarter in an established manner,
characterized in that between the form means and at least some of the data sources of the equipment is adapted to carry out data transmission at least from data source towards form means comprising at least application program data.
